(19) United States
(12) Patent Application Publication
(10) Pub. No.: US 2019/0316657 A1
(43) Pub. Date: Oct. 17, 2019

(54) SEALED HYDRAULIC TENSIONER

(71) Applicant: BorgWarner Inc., Auburn Hills, MI (US)

(72) Inventors: Keith B. Cobb, Cortland, NY (US); Mark Patton, Dryden, NY (US); XiaoJian Lu, Shanghai (CN); Kevin Todd, Freeville, NY (US); Dale N. Smith, Freeville, NY (US); Fabio Magni, Monza (IT); Ron J. Mielbrecht, Ithaca, NY (US); Glenn Swanson, Lansing, NY (US); Giuseppe Baddaria, Montevecchia (IT)

(21) Appl. No.: 16/378,873

(22) Filed: Apr. 9, 2019

Related U.S. Application Data
(60) Provisional application No. 62/656,252, filed on Apr. 11, 2018.

(51) Int. Cl. F16H 7/08; F02B 67/06; F02F 11/00; F01L 1/02; F01L 1/047

(52) U.S. Cl. CPC F16H 7/08; F02B 67/06; F16H 2007/0806; F01L 1/022; F01L 1/047; F02F 11/002

(57) ABSTRACT

A sealed hydraulic tensioner includes a cylinder having a cylinder surface formed in a housing; a piston, received by the cylinder, having an inner surface forming a piston cavity and an outer surface that closely conforms in shape to the cylinder inhibiting the flow of fluid between the outer surface of the piston and the cylinder surface; a tensioner biasing member engaging the piston and the cylinder forcing the piston in an axial direction; a check valve regulating fluid flow between a high-pressure chamber and a low-pressure chamber; one or more apertures formed in the piston extending between the inner surface and the outer surface of the piston that communicate fluid between the piston cavity and the cylinder, wherein a substantially fixed quantity of fluid is encapsulated within the piston cavity and the cylinder.

### CROSS-REFERENCE TO RELATED APPLICATIONS

This application claims the benefit of U.S. Patent Application No. 62/656,252 filed on Apr. 11, 2018, the disclosure of which is herein incorporated by reference in its entirety.

### TECHNICAL FIELD

The present application relates to internal combustion engines (ICEs) and, more particularly, to hydraulic tensioners used with ICEs.

### BACKGROUND

Internal combustion engines (ICEs) have valvetrains that include a crankshaft and one or more camshafts that receive rotational force from the crankshaft and actuate intake/exhaust valves. Rotational output from the crankshaft can be communicated to the camshaft(s) via a chain. The chain can loop around a crankshaft sprocket attached to the crankshaft and one or more camshaft sprockets that are each attached to an end of the camshaft(s). Over time, the chain linking the crankshaft and the camshaft(s) can change in length and chain tensioners can be used to maintain an optimal amount of tension on the chain.

Chain tensioners may be hydraulically actuated and rely on a supply of fluid provided by the ICE. For instance, engine oil used to lubricate internal elements of the ICE can be communicated to the hydraulic tensioner and pressurized so that a piston can exert force against the chain and add tension to the chain. However, locating the chain tensioner relative to a fluid supply provided by an ICE can limit the locations on the ICE where the chain tensioner can be positioned. As ICEs become more compact, it can be helpful to locate a chain tensioner on an ICE without regard to a supply of fluid.

### SUMMARY

In one implementation, a sealed hydraulic tensioner includes a cylinder having a cylinder surface formed in a housing; a piston, received by the cylinder, having an inner surface forming a piston cavity and an outer surface that closely conforms in shape to the cylinder inhibiting the flow of fluid between the outer surface of the piston and the cylinder surface; a tensioner biasing member engaging the piston and the cylinder forcing the piston in an axial direction; a check valve, located in the piston cavity, regulating fluid flow between a high-pressure chamber and a low-pressure chamber; one or more apertures formed in the piston extending between the inner surface and the outer surface of the piston that communicate fluid between the piston cavity and the cylinder; and a piston seal, located axially along the piston between the aperture(s) and an end of the piston, having an outer seal surface that abuts the cylinder surface and an inner seal surface that abuts the outer surface of the piston, wherein a substantially fixed quantity of fluid is encapsulated within the piston cavity and the cylinder.

In another implementation, a sealed hydraulic tensioner includes a cylinder having a cylinder surface formed in a housing; a piston, received by the cylinder, having an inner surface forming a piston cavity and an outer surface, wherein along a first axial length of the piston the outer surface of the piston closely conforms in shape to the cylinder surface inhibiting the flow of fluid between the outer surface of the piston and the cylinder surface and along a second axial length of the piston the diameter of the outer surface of the piston is less than the diameter of the cylinder; a tensioner biasing member engaging the piston and the cylinder forcing the piston in an axial direction; a check valve, located in the piston cavity, regulating fluid flow between a high-pressure chamber and a low-pressure chamber; one or more apertures formed in the piston extending between the inner surface and the outer surface of the piston that communicate fluid between the piston cavity and the cylinder; and a piston seal, located along the second axial length of the piston between the aperture(s) and an end of the piston, having an outer seal surface that abuts the cylinder surface and an inner seal surface that abuts the outer surface of the piston, wherein a substantially fixed quantity of fluid is encapsulated within the piston cavity and the cylinder.

In yet another implementation, a sealed hydraulic tensioner includes a cylinder having a cylinder surface formed in a housing; a piston, received by the cylinder, with an outer surface having a substantially uniform diameter and conforming in shape to the cylinder surface, wherein the piston includes a low-pressure cavity and a high-pressure cavity; a tensioner biasing member engaging the piston and the cylinder within the high-pressure cavity forcing the piston in an axial direction; a check valve, located in the piston cavity, regulating fluid flow between the high-pressure cavity and the low-pressure cavity; one or more apertures formed in the piston extending between the inner surface and the outer surface of the piston that communicate fluid between the low-pressure cavity and the cylinder; a piston seal, located between the aperture(s) and an end of the piston, having an outer seal surface that abuts the cylinder surface and an inner seal surface that abuts the surface of the piston, wherein a substantially fixed quantity of fluid is encapsulated within the piston chamber and the cylinder.

### BRIEF DESCRIPTION OF THE DRAWINGS

FIG. 1 is a cross-sectional view depicting an implementation of a sealed hydraulic tensioner; and

FIG. 2 is a cross-sectional view depicting another implementation of a sealed hydraulic tensioner.

### DETAILED DESCRIPTION

A sealed hydraulic tensioner includes a cylinder receiving a piston that slides relative to the cylinder. The piston can include an inner surface that defines a piston cavity. The combination of the cylinder and the piston defines a closed or sealed space that prevents the escape of fluid from the hydraulic tensioner. The hydraulic tensioner can be partitioned into a low-pressure chamber and a high-pressure chamber using a check valve as well as using the space between the cylinder and the closely conforming outer surface of the piston. Fluid can flow between the low-pressure chamber and the high-pressure chamber within the hydraulic tensioner without adding or removing fluid. The piston slides relative to the cylinder to engage a chain and increase the tension of the chain about the crankshaft sprocket and camshaft sprocket(s). Fluid can flow from the low-pressure chamber to the high-pressure chamber as the piston slides relative to the cylinder and extends toward the chain. As the chain contracts and exerts a force on the piston pushing it toward the hydraulic tensioner and back into the cylinder, fluid can flow from the high-pressure chamber into the low-pressure chamber within the hydraulic tensioner. Regardless of whether the piston is moving toward or away from the chain, the volume of fluid remaining in the hydraulic tensioner remains substantially fixed.

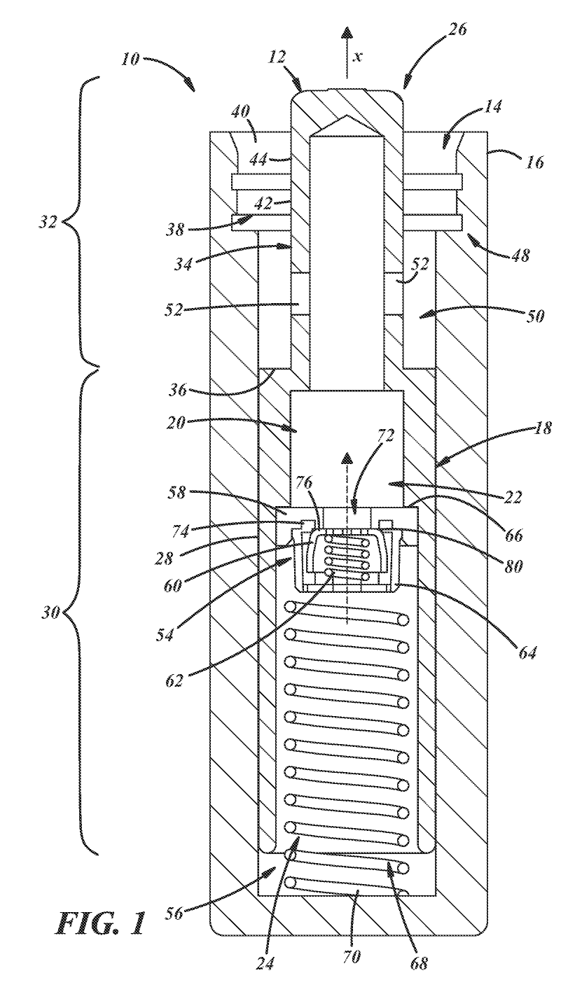

An implementation of a sealed hydraulic tensioner 10 is shown in FIG. 1. The sealed hydraulic tensioner 10 includes a piston 12 and a cylinder 14 formed within a housing 16 that receives the piston 12. The piston 12 has an outer surface 18 and an inner surface 20. The inner surface 20 forms a piston cavity 22 that is defined by an open end 24 of the piston 12 and a closed end 26 of the piston 12. The outer surface 18 can be shaped to closely conform to a surface 28 of the cylinder 14 such that when the piston 12 is received by the cylinder 14 the outer surface 18 of the piston 12 abuts the surface 28 of the cylinder 14. While the piston 12 and the cylinder 14 are shown in this implementation to have an annular shape, it should be understood that other different piston and cylinder shapes are possible. Along a first axial length 30 of the piston 12, the outer surface 18 of the piston 12 fits closely against the cylinder surface 28 so that it inhibits the flow of fluid between the outer surface 18 of the piston 12 and the cylinder surface 28. While the piston 12 abuts the cylinder 14, fluid pressure can rise to a level above which fluid flows between the piston 12 and the cylinder 14 despite the close conformity. Along a second axial length 32 of the piston 12, the piston 12 includes a reduced diameter section 34 having a smaller diameter than the cylinder 14. The reduced diameter section 34, can include a piston shoulder 36 where the first axial length 30 meets the second axial length 32.

A piston seal 38 can be positioned near an open end 40 of the cylinder 14. The piston seal 38 can be annularly shaped and have an inner seal surface 42 that engages an outer surface 44 of the reduced diameter section of the piston 12 as well as an outer seal surface 46 than engages the cylinder surface 28. A receiving feature 48 in the cylinder surface 28 can keep the piston seal 38 positioned axially with respect to the cylinder 14. In this implementation, the receiving feature 48 can be an annular groove having a diameter that is larger than the diameter of the cylinder 14. The piston seal 38 can be compressed radially inwardly during installation relative to the cylinder surface 28 and axially moved into engagement with the receiving feature 48. When the piston seal 38 is axially aligned along the piston 12 with the receiving feature 48, the piston seal 38 expands radially outwardly to engage the receiving feature 48. The receiving feature 48 is then prevented from axial movement relative to the cylinder 14. The piston seal 38 can inhibit the flow of fluid from a low-pressure chamber 50 outside of the hydraulic tensioner 10 yet also permit the piston 12 to slide relative to the inner seal surface 42. One or more apertures 52 can be positioned along the reduced diameter section 34 and communicate fluid between the piston cavity 22 and the cylinder 14 within the low-pressure chamber 50 of the hydraulic tensioner 10.

The piston 12 includes a check valve assembly 54 that regulates the flow of fluid between a high-pressure chamber 56 and the low-pressure chamber. The check valve assembly 54 can include a check valve seat 58, a check valve 60, a biasing member 62, and a check valve retainer 64. The check valve assembly 54 can abut an inner shoulder 66 formed along the inner surface 20 of the piston 12 within the piston cavity 22 forming a fluid resistant seal between the low-pressure chamber 50 and the high-pressure chamber 56. A tensioner biasing member 68 that forces the piston 12 to slide with respect to the cylinder 14 can engage the check valve assembly 54 and a closed end 70 of the cylinder 14 transmitting force to the piston 12 through the check valve assembly 54. The check valve seat 58 can include a check valve aperture 72 through which fluid selectively flows between the high-pressure chamber 56 and the low-pressure chamber 50. An annular recess 74 can at least partially surround the check valve aperture 72 and can permit the check valve 60 to be opened in response to pressure generated in either the low-pressure chamber 50 or the high-pressure chamber 56. The check valve biasing member 62 engages a check valve member 76 into releasable engagement with the check valve aperture 72. The check valve biasing member 76 and the check valve member 76 can be held in position in relation to the check valve aperture 72 by the check valve retainer 64. The check valve retainer 64 can be coupled with the check valve seat 58 such that the check valve biasing member 62 may engage the retainer 64 and force the check valve member 76 to engage with the check valve seat 58 closing off the check valve aperture 72 from fluid flow. When the check valve member 76 is biased into engagement with the aperture 72, fluid flow between the high-pressure chamber 56 and the low-pressure chamber 50 is inhibited. But when sufficient fluid pressure builds in the low-pressure chamber 50, such as when the piston 12 is sliding relative to the cylinder 14 toward the chain and away from the housing 16, the check valve biasing member 62 can be compressed releasing the check valve member 76 from its default position engaging the check valve aperture 72. In some implementations, the check valve member 76 can be implemented using a disk that includes a substantially planar portion 78 that engages the check valve seat 58 and prevents the flow of fluid between the high-pressure chamber 56 and the low-pressure chamber 50 but also includes one or more holes 80 in the disk that permit a defined amount of fluid or rate of fluid flow to pass through the holes even when the check valve member 76 is biased into engagement with the check valve aperture 72. In other implementations, the check valve member 76 can be implemented as a solid element, such as a ball used with a ball valve. Implementing the check valve member as a ball valve can include a check valve seat with holes passing between the high-pressure chamber to the low-pressure chamber permitting fluid flow therebetween. It should be appreciated that the check valve can be implemented in any one of a variety of ways.

The hydraulic tensioner 10 can be assembled by positioning the cylinder 14 with the open end 40 facing upwards. A defined quantity of fluid can be added to the cylinder 14. The fluid can be engine oil commonly used as a lubricant in ICEs or one of many other hydraulic fluids. The tensioner biasing member 68 can be inserted into the cylinder 14 for engaging the check valve assembly 54 located within the piston cavity 22. The piston 12 along with the check valve assembly 54 can then be positioned so that the open end of the piston 24 faces the open end of the cylinder 40; the piston 12 is then axially slid into the cylinder 14 until the check valve assembly 54 engages and compresses the tensioner biasing member 68. The piston seal 38 can be placed over the reduced diameter section 34 of the piston 12 engaging the receiving feature 48 of the cylinder surface 28 and the outer surface 18 of the piston 12 along the reduced diameter section 34. The piston shoulder 36 can engage with the piston seal 38 to resist the axial movement of the piston 12 away from the hydraulic tensioner 10.

The hydraulic tensioner 10 can be placed in close proximity to the chain of an ICE and the tensioner biasing member 68 can move the piston 12 away from the tensioner 10 toward and into engagement with the chain of the ICE so that the piston 12 exerts force on the chain to apply tension. Fluid from the low-pressure chamber 50 can flow into the high-pressure chamber 56 in response to the piston 12 moving away from the hydraulic tensioner 10. The check valve member 76 moves away from the check valve aperture 72 and fluid flows through the check valve aperture 72 from the low-pressure chamber 50 to the high-pressure chamber 56. When the chain applies force against the piston 12 directed toward the cylinder 14, the piston 12 can slide toward the cylinder 14 and fluid can flow from the high-pressure chamber 56 to the low-pressure chamber 50. Fluid can flow from the high-pressure chamber 56 in between the cylinder surface 28 and the outer surface 18 of the piston 12 in response to the increased fluidic pressure created in the high-pressure chamber 56. In addition, fluid can flow from the high-pressure chamber 56 to the low-pressure chamber 58 through the check valve 60. The fluid can flow through one or more holes 80 in the check valve member 76. The size and quantity of the holes 80 can be selected to determine a flow rate between the high-pressure chamber 56 and the low-pressure chamber 50 and control the stiffness and/or damping performance of the tensioner 10.

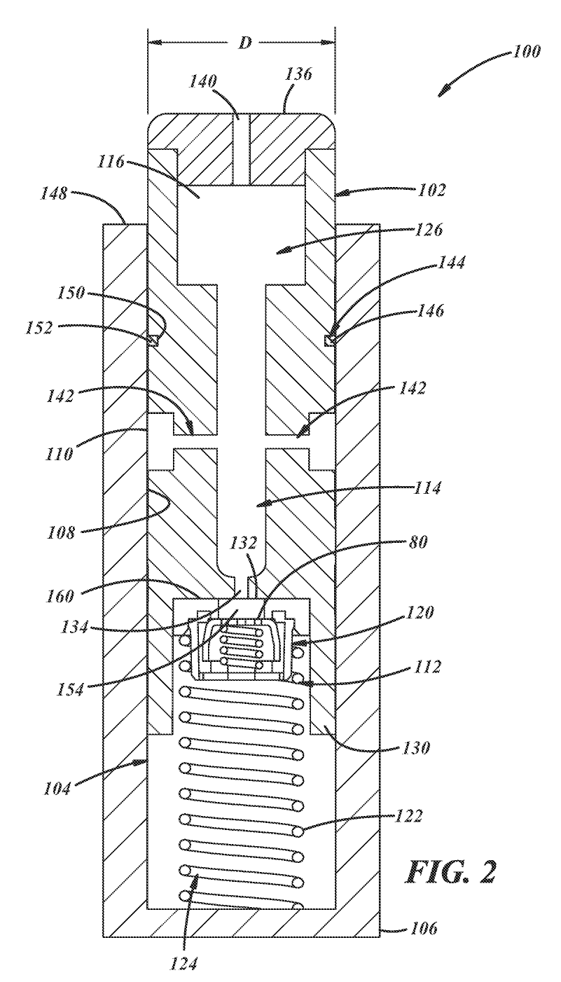

Turning to FIG. 2, another implementation of a sealed hydraulic tensioner 100 is shown. The hydraulic tensioner 100 includes a piston 102 and a cylinder 104 formed within a housing 106 that receives the piston 102. An outer surface of the piston 108 can have a substantially fixed outer diameter (D) that, when the piston 102 is inserted into the cylinder 104, closely conforms to a surface 110 of the cylinder 104 and inhibits the flow of fluid between the outer surface 108 of the piston 102 and the cylinder surface 110. The diameter (D) is substantially fixed such that the diameter is a single value but may vary slightly due to manufacturing tolerances. The piston 102 includes a high-pressure cavity 112 and a low-pressure cavity 114. The high-pressure cavity 112 can be formed in one end 130 of the piston 102 such that the piston 102 has an open end and the high-pressure cavity 112 receives a check valve assembly 120 and the tensioner biasing member 122. The high-pressure cavity 112 is included in a high-pressure chamber 124. The check valve assembly 120 and the tensioner biasing member 122 can be implemented as is described above with respect to FIG. 1. The low-pressure cavity 114 can be formed in an opposite end 116 of the piston 102 and is included in the low pressure chamber 126. The low-pressure cavity 114 can be open at the opposite end 116 of the piston 102 and separated from the high-pressure cavity 112 by a partition 132. An aperture 134 capable of communicating fluid between the high-pressure cavity 112 and the low-pressure cavity 114 fluidly connects the high-pressure cavity 112 and the low-pressure cavity 114 and is formed in the partition 132. A piston plug 136 can be inserted into the opposite end 116 of the piston 102 to form a surface that delivers force to the chain and encloses the low pressure cavity 114. The piston plug 136 can optionally include a vent 140 that permits ambient air to reach the low-pressure cavity 114.

The low-pressure cavity 114 also includes one or more radially-outwardly extending fluid paths 142 that communicate fluid between the low-pressure cavity 114 and the cylinder 104. In this implementation, fluid paths 142 carry fluid from the low-pressure chamber 126 to the outer surface 108 of the piston 102. A receiving feature 144, such as an annular groove formed from a reduced diameter section on the outer surface 108 of the piston 102 along an axial length of the piston 102. A piston seal 146 can be positioned on the outer surface 108 of the piston 102 in between an end 148 of the cylinder 104 and the fluid paths 142. The outer surface 108 of the piston 102 includes the receiving feature 144, such as an annular groove, that receives the piston seal 146 that prevents the flow of fluid outside of the hydraulic tensioner 100. The piston seal 146 can be positioned near the open end 148 of the cylinder 104. The piston seal 146 can have an inner seal surface 150 that engages an outer surface 108 of the piston 102 as well as an outer seal surface 152 than engages the cylinder surface 110. The receiving feature 144 is included in the piston 102 and can keep the piston seal 146 positioned axially with respect to the piston 102. In this implementation, the receiving feature 144 can be an annular groove having a diameter that is smaller than the outer surface 108 of the piston 102. The piston seal 146 can be expanded radially outwardly during installation relative to the outer surface 108 of the piston 102 and axially moved into engagement with the receiving feature 144. When the piston seal 146 is axially aligned with the receiving feature 144, the piston seal 146 contracts radially inwardly to engage the receiving feature 144. The receiving feature 144 is then prevented from axial movement relative to the piston 102. The piston seal 146 can inhibit the flow of fluid from the low-pressure chamber 126 outside of the housing 106 yet also permit the piston 102 to slide relative to the inner seal surface 150.

The hydraulic tensioner 100 can be assembled in a similar way as is described with respect to FIG. 1. The tensioner biasing member 122 can be inserted into the cylinder 104 for engaging the check valve assembly 120 located within the high-pressure cavity 112 and abutting a portion of the high-pressure cavity 112. The piston seal 146 can be placed over the outer surface 108 of the piston 102, engaging the receiving feature 144 of the piston 102. The piston 102 along with the check valve assembly 120 can then be positioned so that the end 130 of piston 102 and the high-pressure cavity 112 faces the open end 148 of the cylinder 104; the piston 102 is then axially slid into the cylinder 104 until the check valve assembly 120 engages and compresses the tensioner biasing member 122. The outer surface of the piston seal 146 abuts the cylinder surface 110.

The tensioner biasing member 122 can move the piston 102 away from the hydraulic tensioner 100 toward and into engagement with the chain of the ICE as the tensioner 100 exerts force on the chain to apply tension. Fluid from the low-pressure chamber 126 can flow into the high-pressure chamber 124 in response to the piston 102 moving toward the chain. The check valve member 154 moves away from the check valve aperture 134 and fluid flows through the aperture 134 from the low-pressure chamber 126 to the high-pressure chamber 124. When the chain applies force against the piston 102 directed toward the cylinder 104, the piston 102 can slide toward the cylinder 104 and fluid can flow from the high-pressure chamber 124 to the low-pressure chamber 126. Fluid can flow from the high-pressure chamber 124 in between the cylinder surface 110 and the outer surface 108 of the piston 102 in response to the increased fluidic pressure created in the high-pressure chamber 124. Fluid flows from the high-pressure chamber 124, along the surface of the piston 102 to reach the radially-outwardly extending fluid paths 142 and returns to the low-pressure chamber 126. In addition, fluid can flow from the high-pressure chamber 124 to the low-pressure chamber 126 through the check valve. The fluid can flow through holes 158 in the check valve member 154 or the check valve member 154 can be displaced from check valve seat 160 due to the increased pressure in the high-pressure chamber 124.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiments) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A sealed hydraulic tensioner comprising:
a cylinder having a cylinder surface formed in a housing;
a piston, received by the cylinder, having an inner surface forming a piston cavity and an outer surface that closely conforms in shape to the cylinder inhibiting the flow of fluid between the outer surface of the piston and the cylinder surface;
a tensioner biasing member engaging the piston and the cylinder forcing the piston in an axial direction;
a check valve, located in the piston cavity, regulating fluid flow between a high-pressure chamber and a low-pressure chamber;
one or more apertures formed in the piston extending between the inner surface and the outer surface of the piston that communicate fluid between the piston cavity and the cylinder; and
a piston seal, located axially along the piston between the aperture(s) and an end of the piston, having an outer seal surface that abuts the cylinder surface and an inner seal surface that abuts the outer surface of the piston, wherein a substantially fixed quantity of fluid is encapsulated within the piston cavity and the cylinder.

2. The sealed hydraulic tensioner recited in claim 1, further comprising a piston seal fit into a receiving feature formed in the cylinder surface.

3. The sealed hydraulic tensioner recited in claim 1, further comprising a piston seal fits into receiving feature formed in the outer surface of the piston.

4. The sealed hydraulic tensioner recited in claim 1, wherein the check valve comprises a check valve member, releasably biased into engagement with a check valve aperture, that prevents the flow of fluid between the high-pressure chamber and the low-pressure chamber and includes a substantially planar portion having one or more apertures that permit a metered amount of fluid to pass through the holes even when the check valve member is biased into engagement with the check valve aperture.

5. The sealed hydraulic tensioner recited in claim 1, wherein the piston further comprises a reduced diameter section.

6. The sealed hydraulic tensioner recited in claim 1, further comprising an end cap received by the piston.

7. The sealed hydraulic tensioner recited in claim 6, wherein the end cap further comprises a vent.

8. A sealed hydraulic tensioner comprising:
a cylinder having a cylinder surface formed in a housing;
a piston, received by the cylinder, having an inner surface forming a piston cavity and an outer surface, wherein along a first axial length of the piston the outer surface of the piston closely conforms in shape to the cylinder surface inhibiting the flow of fluid between the outer surface of the piston and the cylinder surface, and along a second axial length of the piston the diameter of the outer surface of the piston is less than the diameter of the cylinder;
a tensioner biasing member engaging the piston and the cylinder forcing the piston in an axial direction;
a check valve, located in the piston cavity, regulating fluid flow between a high-pressure chamber and a low-pressure chamber;
one or more apertures formed in the piston extending between the inner surface and the outer surface of the piston that communicate fluid between the piston cavity and the cylinder; and
a piston seal, located along the second axial length of the piston between the aperture(s) and an end of the piston, having an outer seal surface that abuts the cylinder surface and an inner seal surface that abuts the outer surface of the piston, wherein a substantially fixed quantity of fluid is encapsulated within the piston cavity and the cylinder.

9. The sealed hydraulic tensioner recited in claim 8, wherein the check valve comprises a check valve member, releasably biased into engagement with a check valve aperture, that prevents the flow of fluid between the high-pressure chamber and the low-pressure chamber and includes a substantially planar portion having one or more apertures that permit a metered amount of fluid to pass through the holes even when the check valve member is biased into engagement with the check valve aperture.

10. The sealed hydraulic tensioner recited in claim 8, further comprising an end cap received by the piston.

11. The sealed hydraulic tensioner recited in claim 10, wherein the end cap further comprises a vent.

12. A sealed hydraulic tensioner comprising:
a cylinder having a cylinder surface formed in a housing;
a piston, received by the cylinder, with an outer surface having a substantially uniform diameter and conforming in shape to the cylinder surface, wherein the piston includes a low-pressure cavity and a high-pressure cavity;
a tensioner biasing member engaging the piston and the cylinder within the high-pressure cavity forcing the piston in an axial direction;
a check valve, located in the piston cavity, regulating fluid flow between the high-pressure cavity and the low-pressure cavity;
one or more apertures formed in the piston extending between the inner surface and the outer surface of the piston that communicate fluid between the low-pressure cavity and the cylinder;
a piston seal, located between the aperture(s) and an end of the piston, having an outer seal surface that abuts the cylinder surface and an inner seal surface that abuts the surface of the piston, wherein a substantially fixed quantity of fluid is encapsulated within the piston chamber and the cylinder.

13. The sealed hydraulic tensioner recited in claim 12, wherein the check valve comprises a check valve member, releasably biased into engagement with a check valve aperture, that prevents the flow of fluid between the high-pressure chamber and the low-pressure chamber and includes a substantially planar portion having one or more apertures that permit a metered amount of fluid to pass through the holes even when the check valve member is biased into engagement with the check valve aperture.

14. The sealed hydraulic tensioner recited in claim 12, further comprising an end cap received by the piston.

15. The sealed hydraulic tensioner recited in claim 14, wherein the end cap further comprises a vent.
